(19) United States
(12) Patent Application Publication
(10) Pub. No.: US 2008/0191382 A1
(43) Pub. Date: Aug. 14, 2008

(54) BARRIER FILTER AND METHOD FOR MANUFACTURING THE SAME

(75) Inventors: Taisuke SATO, Hamamatsu-shi (JP); Kazuhiro YOSHIDA, Hamamatsu-shi (JP)

Correspondence Address: Young & Thompson, 2nd Floor, 745 S. 23rd Street, Arlington, VA, 22202, US

(73) Assignee: TOYO ROKI SEIZO KABUSHIKI KAISHA, Hamamatsu-shi (JP)

(21) Appl. No.: 12/029,022

(22) Filed: Feb. 11, 2008

(30) Foreign Application Priority Data
Feb. 9, 2007 (JP) 2007-030771

(51) Int. Cl. B29C 70/28; B01D 29/05

(52) U.S. Cl. 264/219; 210/483

(57) ABSTRACT

To provide a barrier filter in which a filter element does not peel from a holding frame. A barrier filter has a cylindrical outline and includes holding frame 1 and filter element 40 arranged on a circumference surface, in which holding frame 1 includes small diameter frame 2 forming one end axially, ring-shaped large diameter frame 10 forming the other end, and circumference frame 20 inclined radially in the circumference surface, for linking small and large diameter frames 2 and 10. On an inner surface of large diameter frame 10, thick-walled portion 15 inclined inward to an inclined circumference surface is formed, the filter element is rounded and formed hollow in a truncated cone shape, an upper end edge portion thereof is inserted into small diameter frame 2 and a lower end edge portion is inserted into large diameter frame 10 outside thick-walled portion 15 to hold the filter element.

### BACKGROUND OF THE INVENTION

1. Field of the Invention

The present invention relates to a barrier filter for filtering out impurities in oil, particularly to a barrier filter provided in a power steering circuit of automobiles and a method for manufacturing the same.

2. Description of the Related Art

As for a barrier filter for filtering out impurities in oil flowing in a power steering circuit of automobiles, has been conventionally used. The barrier filter has a cylindrical outline, and includes a holding frame made of resin material, and filter elements integrally formed with the holding frame. The holding frame includes a ring-shaped portion placed at one end in an axial direction of the barrier filter, a ring-shaped or disk-like portion placed at the other end, and a plurality of circumference frames for connecting these. On the one hand, for the filter elements, a net having fine mesh is used.

In such barrier filter, both ends in the axial direction of the filter element placed on a circumference surface of the barrier filter and formed hollow in a cylindrical shape are held by the portions situated at both ends of the holding frame, and supported by the circumference frames.

At the time of manufacturing the barrier filter including such configuration, there are some production methods, and Patent Document 1 shows one example thereof.

In a barrier filter disclosed in Patent Document 1, a holding frame is formed by injection molding of resin material. That is, a filter element rounded in a cylindrical shape is beforehand placed in a cavity formed in a mold, and resin is injected into the inside thereof to manufacture the holding frame to be integrated with the filter element.

[Patent Document 1] Japanese Patent Laid-Open No. 5-193023

### SUMMARY OF THE INVENTION

However, the barrier filter shown in Patent Document 1 may be molded in a state that, upon injecting resin into the mold, an end edge portion of the filter element placed in the cavity is caused by the resin to flow, and located in close vicinity to a surface of a core pin. Then, a completed barrier filter is a product formed in a state that, at an end portion in an axial direction thereof, an end edge portion of the filter element is not necessarily located at a central portion of a wall thickness of a ring-shaped portion, and only adheres to an inner surface.

When such barrier filter is installed in a circuit to use, pressure of oil flowing in the circuit easily peels the filter element off a ring-shaped frame, which causes the barrier filter not to function.

Then, the present invention provides a barrier filter for achieving a stable filtering function, in which a filter element is surely held by a holding frame, and a method for manufacturing the same.

Then, the present invention, first, to solve the above problem, adopts a barrier filter formed of a holding frame made of resin material and a filter element held by the holding frame in a cylindrical shape, and having the filter element placed at least on a circumference surface, in which: the holding frame includes a small diameter frame forming one end in an axial direction of the barrier filter, a ring-shaped, large diameter frame forming the other end, and a circumference frame inclined inward and outward in a radial direction on the circumference surface of the barrier filter, for linking the small diameter frame and the large diameter frame; on an inner surface of the large diameter frame, a thick-walled portion is formed to be inclined inward relative to a gradient of the circumference surface of the barrier filter; and the filter element is formed hollow in a truncated cone shape, and an end edge portion forming an upper base portion thereof is inserted into the inside of the small diameter frame to be held, and an end edge portion forming a lower base portion thereof is inserted into the inside of the large diameter frame outside the thick-walled portion to be held.

Regarding such barrier filter, in the present invention, in the thick-walled portion of the large diameter frame, provided is a protective portion preventing filter element from shifting where a concave portion and a convex portion are alternately placed in a circumferential direction, and the end edge portion forming the lower base portion of the filter element is placed outside an outer edge portion of the concave portion constituting the protective portion preventing filter element from shifting to be held.

Further, an intermediate portion formed between the upper base portion and the lower base portion of the filter element is held to pass through the inside of the circumference frame in a circumferential direction.

The present invention, second, to solve the above problem, manufactures the barrier filter by a production method described bellow.

That is, the production method is a method for manufacturing a barrier filter formed of a holding frame made of resin material and a filter element in a cylindrical shape, and having the filter element placed at least on a circumference surface, in which the holding frame includes a small diameter frame forming one end in an axial direction, a ring-shaped, large diameter frame forming the other end, and a plurality of rod-like circumference frames inclined inward and outward in a radial direction on the circumference surface, for linking the small diameter frame and the large diameter frame, and the holding frame is molded by injection molding, the method including: configuring a cavity formed in a mold used for the injection molding to include a small diameter frame mold portion for molding the small diameter frame, a large diameter frame mold portion for molding the large diameter frame, and a circumference frame mold portion for molding the circumference frame so as to make the circumference frame mold portion link the small diameter frame mold portion and the large diameter frame mold portion; forming a thick-walled portion mold portion by providing an inner wall of the large diameter frame mold portion to be inclined inward relative to a gradient made by the circumference frame mold portion; rounding the filter element to be formed hollow in a truncated cone shape, positioning an end edge portion forming an upper base portion thereof at the small diameter frame mold portion, and positioning an end edge portion forming a lower base portion outside the thick-walled portion mold portion to be situated at the large diameter frame mold portion, so that the filter element is arranged in the cavity; and then injecting resin material into the cavity to integrally mold the filter element and the holding frame so that the injected resin holds the end edge portion forming the upper base portion and the end edge portion forming the lower base portion of the filter element.

At this time, upon production according to the present invention, in the thick-walled portion mold portion, a mold portion for a protective portion preventing filter element from shifting where a convex portion protruding outward is arranged is provided at a plurality of positions in a circumferential direction, and the end edge portion forming the lower base portion of the filter element in the large diameter frame mold portion is positioned outside the convex portion in the mold portion for the protective portion preventing filter element from shifting so that the convex portion supports the end edge portion.

According to the present invention, the filter element placed on the circumference surface is formed in a truncated cone shape and inclined in the radial direction of the barrier filter, thereby the end edge portions respectively forming the upper base portion and the lower base portion of the filter element can be configured to be inserted into intermediate portions in a wall thickness direction of the small diameter frame and the large diameter frame. Accordingly, there can be provided the barrier filter in which the filter element is surely held by the holding frame. Further, the large diameter frame has the thick-walled portion formed therein, which provides a configuration in which the end edge portion of the filter element can be easily positioned at the intermediate portion in the wall thickness direction of the large diameter frame.

Further, in the present invention, the protective portion preventing filter element from shifting is formed in the large diameter frame. This protective portion preventing filter element from shifting is formed of the convex portion protruding from within outward, in the thick-walled portion mold portion formed in the mold. This convex portion supports the filter element, which provides a configuration in which the gradient of the filter element is kept to further easily position the end edge portion of the filter element at the intermediate portion in the wall thickness direction of the large diameter frame.

### BRIEF DESCRIPTION OF THE DRAWINGS

FIG. 1 is a perspective view of a barrier filter according to one embodiment of the present invention;

FIG. 2 is a partial, enlarged cross-section view illustrating that a small diameter frame constituting a holding frame holds a filter element;

FIG. 3 is a partial, enlarged cross-section view illustrating that a large diameter frame constituting the holding frame holds the filter element;

FIG. 4 is a perspective view illustrating a part of the barrier filter, seen from back of the large diameter frame;

FIG. 5 is a partial, enlarged cross-section view illustrating that the large diameter frame holds the filter element in a protective portion preventing filter element from shifting;

FIG. 6 is an expansion plan of the filter element to be arranged on a circumference surface of the barrier filter;

FIG. 7 is a perspective view illustrating that the filter element shown in FIG. 6 is rounded to be formed in a truncated cone shape;

FIG. 8 is a perspective view illustrating that two filter elements are used to be formed in a truncated cone shape;

FIG. 9 is a cross-section view of a mold in a portion in which a concave portion for molding the protective portion preventing filter element from shifting is formed;

FIG. 10 is a cross-section view of the mold in a circumferential direction in a portion different from the portion shown in FIG. 9;

FIG. 11 is an illustration of operation in a large diameter frame mold portion upon injecting resin into the mold;

FIG. 12 is a view illustrating a state of the filter element after injecting resin;

FIG. 13 is a perspective view of a barrier filter according to another embodiment different from the barrier filter shown in FIG. 1.

### DETAILED DESCRIPTION OF THE PREFERRED EMBODIMENTS

Now, an embodiment of the present invention will be hereinafter described with reference to the accompanying drawings.

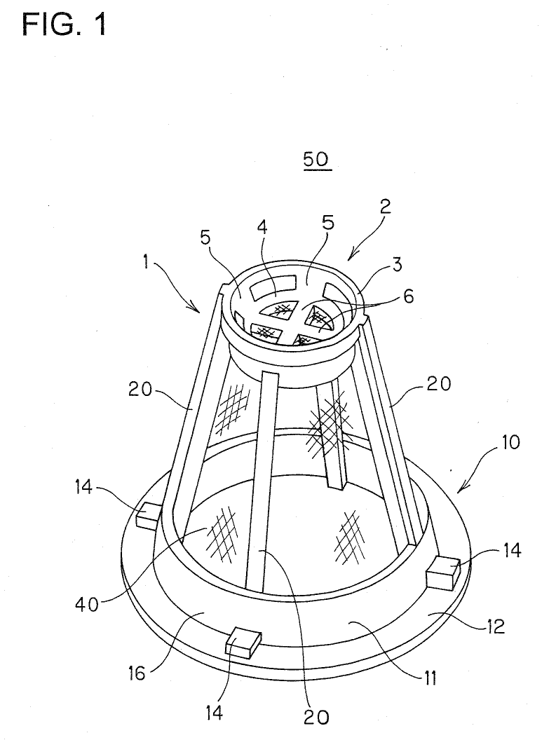

FIG. 1 is a perspective view of a barrier filter 50 according to one embodiment of the present invention. The barrier filter 50 has an outline formed in a truncated cone shape, and includes a holding frame 1 made of resin and filter elements 30 and 40 held by the holding frame 1.

The holding frame 1 includes a small diameter frame 2 forming an upper end, a large diameter frame 10 forming a lower end, and a plurality of circumference frames 20 placed on a circumference surface, for linking the small diameter frame 2 and the large diameter frame 10. The small diameter frame 2 includes an outer ring portion 3 forming an outer edge and an inner ring portion 4 placed inside the outer ring portion 3, and the outer ring portion 3 and the inner ring portion 4 are linked to each other at a plurality of positions in a circumferential direction by a linkage portion 5. Further, inside the inner ring portion 4, a cross rib 6 is provided, and an inner edge of the inner ring portion 4, at positions thereof opposite to each other, is linked by the rib 6. An area between the outer ring portion 3, the inner ring portion 4, the linkage portion 5, and the rib 6 is configured to be a plurality of flow paths into which oil flows.

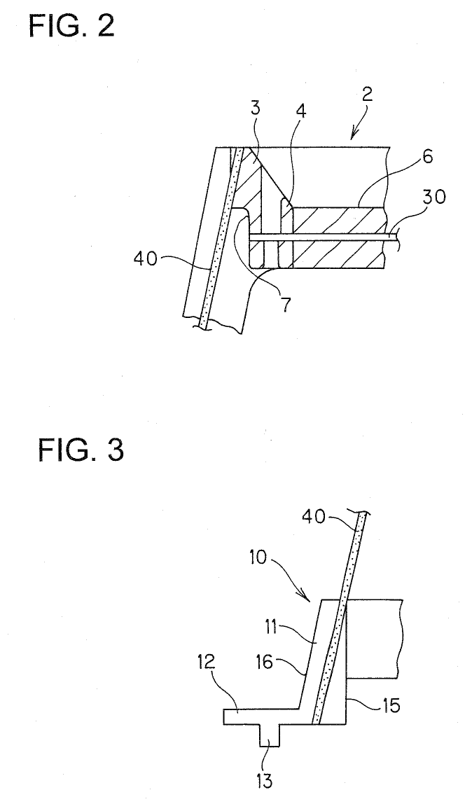

The small diameter frame 2, as shown in FIG. 2, is formed to have a certain height, and an upper surface thereof is formed so that a position of the inner ring portion 4 sinks relative to a position of the outer ring portion 3. Further, an outer circumference surface has a step 7 formed in a boundary portion between the outer ring portion 3 situated at an upper portion and the inner ring portion 4 situated at a lower portion of the small diameter frame 2.

On the one hand, the large diameter frame 10, as shown in FIG. 3, is formed in a ring shape, and includes a circumference wall 11, and a flange 12 extending outward in a radial direction at a lower end edge of the circumference frame 11. Further, on a lower surface of the flange 12, a mounting portion 13 protruding along the entire circumference of the large diameter frame 10 is formed. Further, on a surface of the flange 12, in a circumferential direction, rectangular, protruding portions 14 are provided at four places spaced apart by the central angle of 90° to be linked to an outer circumference surface 16 of the circumference wall 11.

The circumference surface 11 constituting the large diameter frame 10 is inclined inward in a radial direction as an outer circumference surface 16 extends upward, and on the contrary, an inner circumference surface 15 is formed to vertically extend so as to be parallel to an axial direction of the barrier filter 50. In such a way, the inner circumference surface 15 of the circumference wall 11 is configured to be inclined relatively inward in the radial direction in relation to a gradient of the outer circumference surface 16. Accordingly, the inner circumference surface 15 of the circumference wall 11 is configured to be a thick-walled portion, and a wall thickness of the circumference wall 11 is more enlarged as it goes downward.

Then, the circumference frame 20 for linking the small diameter frame 2 and the large diameter frame 10 has a transverse section made rectangular and is configured to be a square bar. Further, the circumference frame 20 is provided at the same positions as the protruding portions 14 formed on the surface of the flange 12 in the circumferential direction, that is, at four places spaced apart by 90° in the circumferential direction.

The circumference frame 20, as shown in FIG. 1, connects the outer circumference side of the small diameter frame 2 and the inner circumference surface 15 side of the large diameter frame 10 to each other. An upper portion of the circumference frame 20 is linked to the outer ring portion 3 in the small diameter frame 2, and an outer surface thereof protrudes outward from the outer circumference surface of the outer ring portion 3. On the one hand, a lower portion of the circumference frame 20 is formed so that an outer surface thereof is coplanar with the outer circumference surface 16 of the circumference wall 11 constituting the large diameter frame 10, and an inner surface protrudes inward from the inner circumference surface 15 of the circumference wall 11.

In the barrier filter 50, such small diameter frame 2 of the holding frame 1 and the circumference surface on which the circumference frame 20 is arranged hold the filter elements 30 and 40. The filter elements 30 and 40 held are nets in which fine mesh is formed.

The filter element 30 held by the small diameter frame 2 is formed circular, and arranged to run across the small diameter frame 2 at an intermediate portion in a height direction of the small diameter frame 2. More specifically, the filter element 30, as shown in FIG. 2, is positioned at a position of the inner ring portion 4 of the small diameter frame 2, and provided to horizontally pass through an intermediate portion of the rib 6. Then, a circumference edge of the filter element 30 is held by the inner ring portion 4 constituting the small diameter frame 2, and the intermediate portion is held by the rib 6. The filter element 30 held in such a way is arranged to block a flow path formed of a gap made between each of the portions constituting the small diameter frame 2.

On the contrary, the filter element 40 arranged on the circumference surface is formed by rounding one or two filter elements 40 to be hollow in a truncated cone shape. The end edge portion forming the upper base portion of the filter element 40, as shown in FIG. 2, is inserted into the inside of the outer ring portion 3 constituting the small diameter frame 2 to be held by the small diameter frame 2. On the one hand, the end edge portion forming the lower base portion, as shown in FIG. 3, is inserted into a central portion in the wall thickness direction of the circumference wall 11 constituting the large diameter frame 10 to be held by the large diameter frame 10. Further, the intermediate portion formed between the upper base portion and the lower base portion is provided to pass through the inside of the circumference frame 20 in the circumferential direction to be held by the circumference frame 20.

On the one hand, the filter element 40 placed on the circumference surface is held by the small diameter frame 2, with the end edge portion forming the upper base portion being inserted outside the small diameter frame 2 and at a slant from beneath into the inside of the outer ring portion 3 as shown in FIG. 2. On the contrary, as shown in FIG. 3, the end edge portion forming the lower base portion is held, with it being inserted from the upper end and the inner circumference edge of the circumference wall 11 constituting the large diameter frame 10 into the intermediate portion in the wall thickness direction of the circumference wall 11 so as to be parallel to the gradient of the outer circumference surface 16.

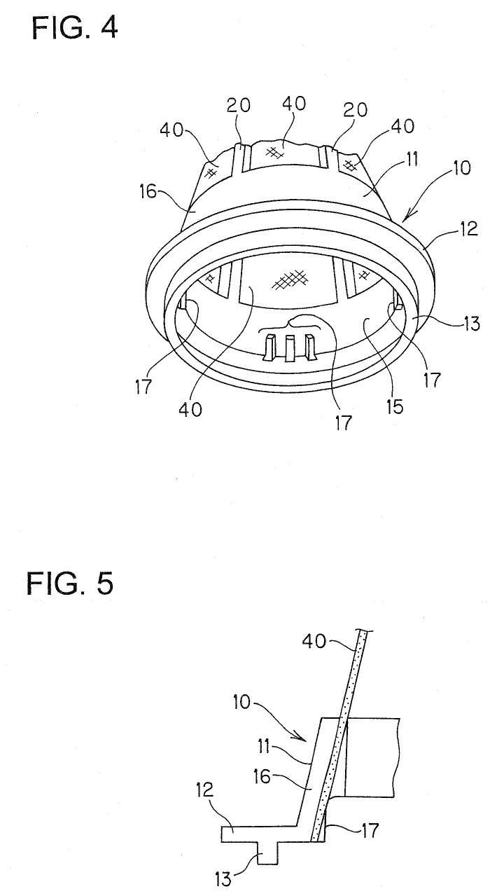

A structure in which the large diameter frame 10 holds the filter element 40 will be in more detail described with reference to FIGS. 4 and 5. FIG. 4 is a perspective view of the large diameter frame 10, seen from the side of a lower surface thereof. FIG. 5 is a partial, enlarged cross-section view illustrating that the large diameter frame holds the filter element in the protective portion preventing filter element from shifting. As shown in FIG. 4, in a lower portion of the inner circumference surface 15 of the large diameter frame 10, there is provided the protective portion preventing filter element from shifting 17 in which the concave portion and the convex portion are alternately arranged in the circumferential direction. In the barrier filter 50 according to the present embodiment, the protective portion preventing filter element from shifting 17 is formed at four places of portions formed between the circumference frames 20 in the circumferential direction.

Further, as shown in FIG. 5, the concave portion constituting the protective portion preventing filter element from shifting 17 is formed so that a portion from a lower end edge to an about intermediate position in a height direction of the circumference wall 11 is dented to the central portion of the wall thickness of the circumference wall 11 on the inner circumference surface 15 of the circumference wall 11. Then, at the positions of these concave portions, the filter element 40 is arranged to abut against a fillet of the concave portion outside the concave portions.

The protective portion preventing filter element from shifting 17 surely holds the end edge portion forming the lower base portion of the filter element 40, preventing peeling off.

In the barrier filter 50 configured in a way described above, the filter elements 40 arranged on the circumference surface are formed in a truncated cone shape and inclined in the radial direction of the barrier filter 50, so that the end edge portion forming the upper base portion can be surely inserted from the outer circumference side of the small diameter frame 2 forming the upper end of the holding frame 1 into the inside in the wall thickness direction to be surely held. On the one hand, the end edge portion forming the lower base portion can be surely positioned at the inside in the wall thickness direction of the large diameter frame to be held without peeling off. Particularly, the structure that the end edge portion forming the lower base portion is surely held by the large diameter frame can be realized by a production method described below.

The method for manufacturing the barrier filter 50 will be hereinafter described.

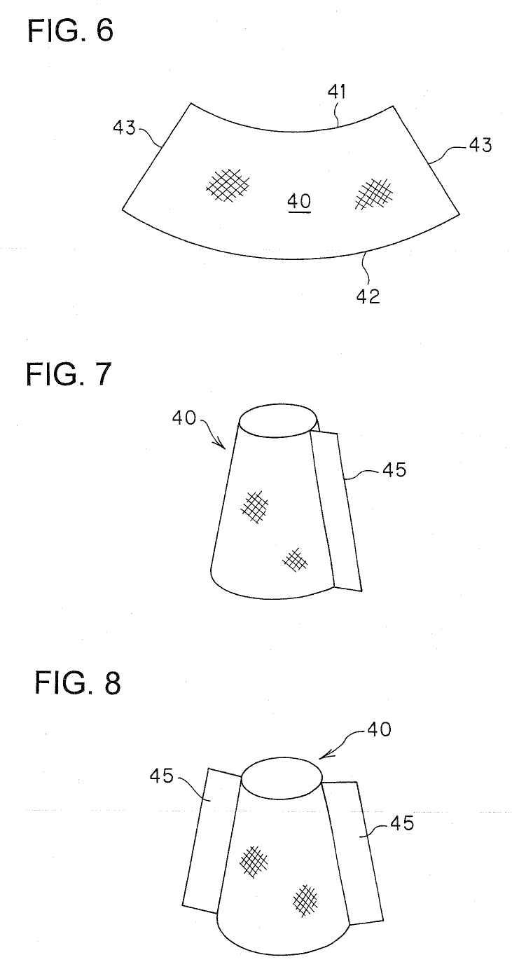

FIG. 6 is an expansion plan of the filter element 40 arranged on the circumference surface of the barrier filter 50 This filter element 40 used is formed to be surrounded by: circular arcs 41 and 42 respectively situated inside and outside of two concentric circles, formed by further cutting off a central portion of a sector form in a sector shape; and linear portions 43 connecting both ends of the circular arcs 41 and 42. Then, as shown in FIG. 7, the filter element 40 is rounded so that the linear portions 43 constituting bath the ends are overlapped with each other in a certain width and the inside thereof is formed hollow in a truncated cone shape. End edges of the linear portions 43 overlapped with each other are protruded outward in a radial direction of the hollow truncated cone shape, forming a projecting portion 45. In addition, when the filter element 40 is formed hollow in a truncated cone shape, two filter elements 40, as shown in FIG. 8, may be used to form. In this case, both ends of the two filter elements 40 are overlapped with each other to protrude the end edges overlapped with each other in an opposite direction, respectively, outward in a radial direction of the hollow truncated cone shape, which forms a pair of projecting portions 45.

The filter element 40 formed in a truncated cone shape in such a way is arranged inside a mold 60 for molding the holding frame 1.

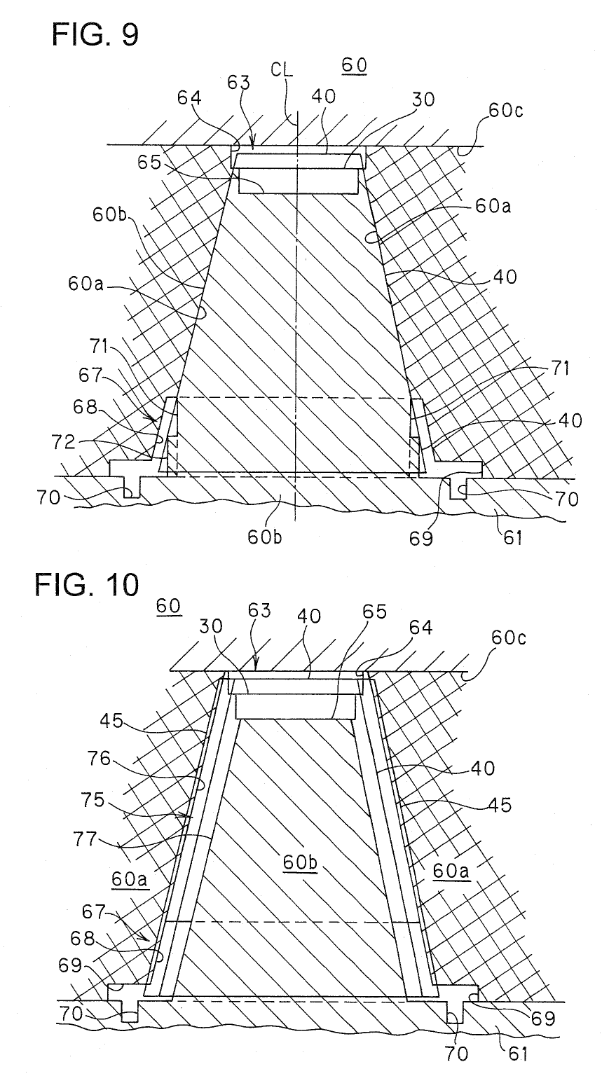

The mold 60 for molding the holding frame 1, as shown in FIGS. 9 and 10, includes four portions: a body 60a for molding an outline; a core 60b placed in a space formed by the body 60a; and a head 60c in which a supply channel of resin is formed. Further, the body 60a includes two components and is configured to be divided to both sides along the center line LC in a state as shown in FIG. 9. In the mold 60 composed of the portions 60a, 60b and 60c, a cavity is formed to supply resin to form the holding frame 1. The cavity includes: a small diameter frame mold portion 63; a large diameter frame mold portion 67 formed to be spaced by a certain distance from the small diameter frame mold portion 63 and parallel to each other; and a circumference frame mold portion 75 formed to connect the small diameter frame mold portion 63 and the large diameter frame mold portion 67.

The space formed by the body 60a is configured to be tapered as it extends in front, and the core 60b is a solid rod formed to be tapered, and its tip portion reaches a tip portion of the space formed by the body 60a. Then, the tip portions of the body 60a and the core 60b are positioned to be closed by the head 60c.

The small diameter frame mold portion 63 includes: a flat, cylindrical portion 64 formed at the tip portion of the space formed by the body 60a; a concave portion 65 in an apical surface of the core 60b; and the head 60c to close an upper end portion. The flat, cylindrical portion 64 is a portion to mold the outer ring portion 3 of the small diameter frame 2, and the concave portion 65 in the apical surface of the core 60b is a portion to mold the inner ring portion 4. In addition, not particularly shown in FIGS. 9 and 10, the small diameter frame mold portion 63 has portions provided therein to mold: the rib 6 for connecting the outer ring portion 3 and the inner ring portion 4; and the cross rib 6 provided inside the inner ring portion 4.

On the contrary, the large diameter frame mold portion 67 includes: a ring-shaped space portion 68 formed on the base side of the space of the body 60a; and an outer circumference surface of the core 60b. The ring-shaped space portion 68 is a portion to mold the circumference wall 11. Further, in the ring-shaped space portion 68, further formed are: a flange mold portion 69 protruding outward; and a mounting portion mold portion 70 perpendicular to the flange mold portion 69. On the one hand, in the core 60b, there is provided a thick-walled portion mold portion 71 that is inclined inward relative to an inclined surface of the circumference surface. The thick-walled portion mold portion 71 is formed to be parallel to an axial direction of the core 60b. Then, at a position of the cross-section shown in FIG. 9, a convex portion 72 protruding outward is formed. The convex portion 72 functions as a mold portion for the protective portion preventing filter element from shifting for molding a concave portion constituting the protective portion preventing filter element from shifting 17 in the inner circumference surface 15 of the large diameter frame 10.

FIG. 10 is a cross-section view taken at a position of the circumference frame mold portion 75 formed in the mold 60. The circumference frame mold portion 75 includes: an outer groove 76 formed in the body 60a; and an inner groove 77 formed in the core 60b. In the body 60a, formed is the outer groove 76 for connecting the small diameter frame mold portion 63 and the large diameter frame mold portion 67 in a mating surface with the core 60b The small diameter frame mold portion 63 side in the outer groove 76 is connected to the flat, cylindrical portion 54 constituting the small diameter frame mold portion 62. On the one hand, the large diameter frame mold portion 67 side is connected to the widened portion 68 for molding the circumference wall 11. A fillet of the outer groove 76 is formed to be coplanar with an inner surface of the ring-shaped space portion 68.

On the contrary, on the circumference surface of the core 60b at a position oppose to the outer groove 76 formed in the body 60a, there is formed the inner groove 77 for connecting the small diameter frame mold portion 63 and the large diameter frame mold portion 67. The small diameter frame mold portion 63 side of the inner groove 77 is connected to a circumference edge portion of the concave portion 65 formed in the apical surface of the core 60b, on the one hand, the large diameter frame mold portion 67 side is connected to the inside of the widened portion 68 for molding the circumference wall 11, extended to a lower end portion of the large diameter frame mold portion 67.

Then, the disk-like filter element 30 is horizontally arranged inside the small diameter frame mold portion 63. Further, the filter element 40 formed hollow in a truncated cone shape is set in the mold 60, with the end edge portion forming the upper base portion thereof being positioned at the small diameter frame mold portion 63, while the end edge portion forming the lower base portion being positioned at the large diameter frame mold portion 67 so that the filter element 40 is sandwiched between the body 60a and the core 60b. At this time, the projecting portion 45 formed by overlapping the end edge portions of the filter elements to each other and protruding them outward, as shown in FIG. 10, is set to be positioned at the circumference frame mold portion 75. Accordingly, after molding, the projecting portion is hidden inside the circumference frame 20.

After the filter elements are set in the mold 60 in a way described above, resin is injected into the cavity in the mold 60 formed of the body 60a, the core 60b and the head 60c. Accordingly, the filter elements 30 and 40 are integrally molded with the holding frame 1.

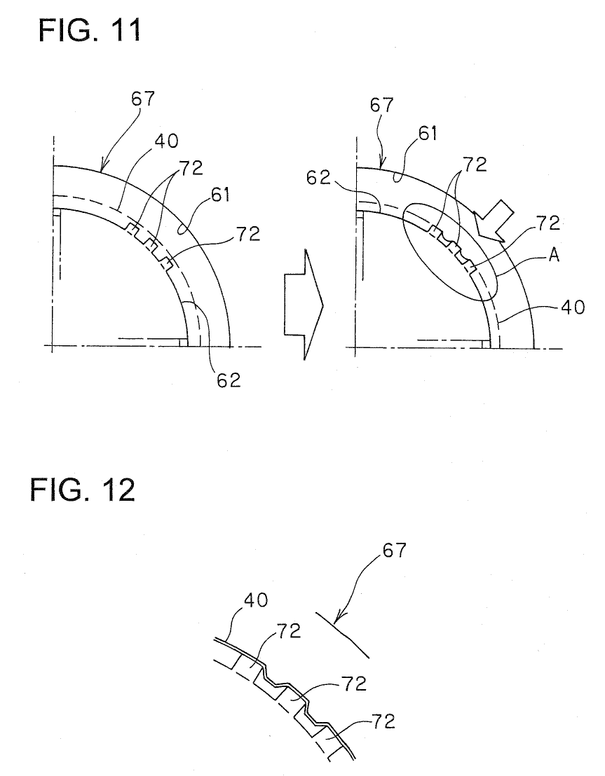

Then, with reference to FIGS. 11 and 12, operation inside the large diameter frame mold portion 67 upon injecting the resin will be described.

In the large diameter frame mold portion 67, as shown in FIG. 11, for example, assuming that the resin flows from outside to inside in a radial direction. When the resin flows in such a way, the end edge portion forming the lower base portion of the filter element 40 is pressed on the convex portion 72 formed in the outer circumference surface of the core 60b. The filter element 40 pressed on is supported by the convex portion 72 while slightly bending inside a concave portion formed between the convex portions 72. Therefore, the gradient of the filter element 40 formed in a truncated cone shape is kept by these convex portions 72. Then, the resin turns along the end edge portion of the filter element 40 and is made to flow into the concave portion.

FIG. 12 shows a state after the resin is injected in such a way, in an enlarged view of the portion A in FIG. 11. As shown in FIG. 12, because the filter element 40 is supported by the convex portion 72, even if the resin flows from outside to inside in the radial direction, the entire circumference of the filter element is prevented from being pressed on the outer circumference surface of the core 60b, the gradient of the filter element 40 is kept, and the filter element 40 is positioned at the intermediate portion of the wall thickness of the large diameter frame 10. Accordingly, in the large diameter frame 10, the filter element 40 can be prevented from peeling completely from the holding frame 1.

Moreover, at a position where this convex portion 72 is formed, the end edge portion forming the lower base portion of the filter element 40 is formed in a waveform in a circumferential direction. Therefore, after molding, a contact area of the filter element 40 with the large diameter frame 10 becomes large, and the filter element 40 is strongly held by the large diameter frame 10, thereby the filter element 40 can be efficiently prevented from shifting and slipping out from the large diameter frame 10.

Injection molding made in such a way described above integrally forms the holding frame 1 and the filter element so that the small diameter frame 2 of the holding frame 1 holds the end edge portion forming the upper base portion of the filter element 40, the large diameter frame 10 holds the end edge portion forming the lower base portion, and the circumference frame 20 holds the intermediate portion, then the barrier filter 50 shown in FIG. 1 is completed.

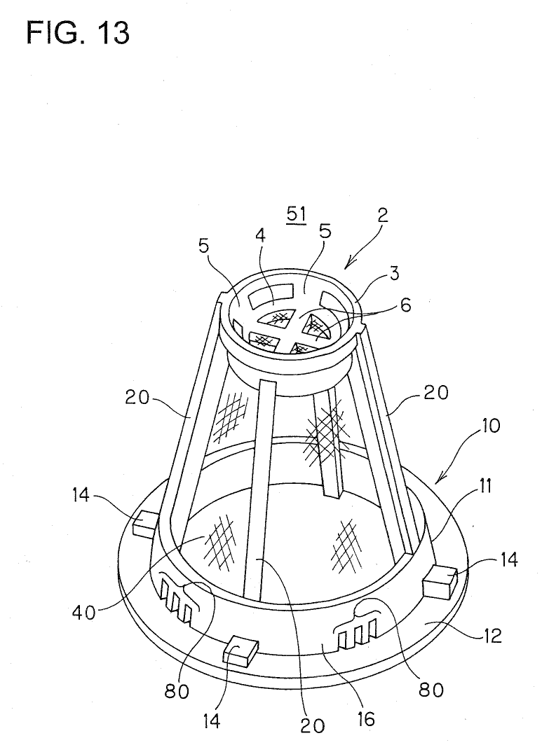

As described above, there has been described, as an example, the case where the protective portion preventing filter element from shifting 17 is provided only on the inner circumference surface 15 side in the large diameter frame 10, but not limited to this, a protective portion preventing filter element from shifting 80, as shown in FIG. 13, may be provided also on the outer circumference surface 16 side of the large diameter frame 10.

A barrier filter 51 shown in FIG. 13 also includes the holding frame 1, and the filter elements 30 and 40 held by the holding frame 1. In addition, because the barrier filter 51 is similar to the barrier filter 50 shown in FIG. 1 except a structure of the outer circumference surface 16 of the large diameter frame 10 constituting the holding frame 1, a like component is denoted by a like symbol as the barrier filter 50 shown in FIG. 1, and the detailed description will be omitted here.

In the outer circumference surface 16 of the large diameter frame 10 constituting the holding frame 1 in a circumferential direction thereof, a protective portion preventing filter element from shifting 80, in which a concave portion and a convex portion are alternately arranged, is provided in a portion formed between the circumference frames 20. The protective portion preventing filter element from shifting 80 is formed at four places spaced apart by 90° in the circumferential direction in the outer circumference surface 16 of the circumference wall 11 constituting the large diameter frame 10. These protective portions for preventing filter element from shifting 80 are respectively formed in areas from a lower end forming a boundary with the flange 12 to an about middle position in a height direction.

When the protective portion preventing filter element from shifting 80 is formed in the outer circumference surface 16 of the large diameter frame 10, the protective portion is provided by forming a convex portion protruding inward on an inner surface of the body 60a of the mold 60 in the large diameter frame mold portion 67. Accordingly, upon injecting resin into the mold 60, even if the resin flows from inside to outside in the large diameter frame mold portion 67, the convex portion maintains the filter element 40 inside the wall thickness of the circumference wall. Therefore, in the completed barrier filter 51, the protective portion preventing filter element from shifting 80 can surely hold the filter element 40.

In addition, in the barrier filters 50 and 51 shown in FIGS. 1 and 13, the thick-walled portion is formed so that the inner circumference surface 15 of the circumference wall 11 constituting the large diameter frame 10 is parallel to an axial direction of the barrier filters 50 and 51, but the thick-walled portion may be formed so that the inner circumference surface 15 is further inclined inward in a radial direction.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2007-30771 filed on Feb. 9, 2007 including the specification, claims, drawings and summary is incorporated herein by reference in its entirety.

1. A barrier filter formed of a holding frame made of resin material and a filter element held by the holding frame in a cylindrical shape, and having the filter element placed at least on a circumference surface, wherein
the holding frame includes a small diameter frame forming one end in an axial direction of the barrier filter, a ring-shaped, large diameter frame forming the other end, and a circumference frame inclined inward and outward in a radial direction on the circumference surface of the barrier filter, for linking the small diameter frame and the large diameter frame,
on an inner surface of the large diameter frame, a thick-walled portion is formed to be inclined inward relative to a gradient of the circumference surface of the barrier filter, and
the filter element is formed hollow in a truncated cone shape, and an end edge portion forming an upper base portion thereof is inserted into the inside of the small diameter frame to be held, and an end edge portion forming a lower base portion thereof is inserted into the inside of the large diameter frame outside the thick-walled portion to be held.

2. The barrier filter according to claim 1, wherein
in the thick-walled portion of the large diameter frame, a protective portion preventing filter element from shifting where a concave portion and a convex portion are alternately placed in a circumferential direction is formed, and
the end edge portion forming the lower base portion of the barrier filter is placed outside an outer edge of the concave portion constituting the protective portion preventing filter element from shifting to be held.

3. The barrier filter according to claim 1, wherein
an intermediate portion formed between the upper base portion and the lower base portion of the filter element is held to pass through the inside of the circumference frame in the circumferential direction.

4. A method for manufacturing a barrier filter formed of a holding frame made of resin material and a filter element in a cylindrical shape, and having the filter element placed at least on a circumference surface, wherein the holding frame includes a small diameter frame forming one end in an axial direction, a ring-shaped, large diameter frame forming the other end, and a plurality of rod-like circumference frames inclined inward and outward in a radial direction on the circumference surface, for linking the small diameter frame and the large diameter frame, and the holding frame is molded by injection molding, the method comprising:
configuring a cavity formed in a mold used for the injection molding to include a small diameter frame mold portion for molding the small diameter frame, a large diameter frame mold portion for molding the large diameter frame, and a circumference frame mold portion for molding the circumference frame so as to make the circumference frame mold portion link the small diameter frame mold portion and the large diameter frame mold portion;
forming a thick-walled portion mold portion by providing an inner wall of the large diameter frame mold portion to be inclined inward relative to a gradient made by the circumference frame mold portion;
forming the filter element to be hollow in a truncated cone shape, positioning an end edge portion forming an upper base portion thereof at the small diameter frame mold portion, and positioning an end edge portion forming a lower base portion outside the thick-walled portion mold portion to be situated at the large diameter frame mold portion, so that the filter element is arranged in the cavity; and
then injecting resin material into the cavity to integrally mold the filter element and the holding frame so that the injected resin holds the end edge portion forming the upper base portion and the end edge portion forming the lower base portion of the filter element.

5. The method for manufacturing a barrier filter according to claim 4, wherein
in the thick-walled portion mold portion, a mold portion for a protective portion preventing filter element from shifting where a convex portion protruding outward is arranged is provided at a plurality of positions in a circumferential direction, and
the end edge portion forming the lower base portion of the filter element in the large diameter frame mold portion is positioned outside the convex portion of the mold portion for the protective portion preventing filter element from shifting so that the convex portion supports the end edge portion.

6. The barrier filter according to claim 2, wherein
an intermediate portion formed between the upper base portion and the lower base portion of the filter element is held to pass through the inside of the circumference frame in the circumferential direction.
